(19) United States
(12) Patent Application Publication
(10) Pub. No.: US 2016/0169400 A1
(43) Pub. Date: Jun. 16, 2016

(54) GAS EXCHANGE VALVE

(71) Applicant: Mahle International GmbH, Stuttgart (DE)

(72) Inventors: Andreas Dogar, Benningen (DE); Stephan Koerner, Besigheim (DE); Reinhard Rose, Fellbach (DE)

(21) Appl. No.: 14/966,522

(22) Filed: Dec. 11, 2015

(30) Foreign Application Priority Data
Dec. 12, 2014 (DE) 102014225741.7

(51) Int. Cl. F16K 25/04; F01L 3/20; F01L 3/04

(52) U.S. Cl. CPC F16K 25/04; F01L 3/04; F01L 3/20

(57) ABSTRACT

A gas exchange valve of an internal combustion engine may include a valve plate and a valve stem. A nickel-phosphorus layer may be disposed on at least the valve stem. The nickel-phosphorus layer may have a phosphorus content that is greater than 10 percent by volume. A method and apparatus for coating a gas exhaust valve are also disclosed.

### CROSS-REFERENCE TO RELATED APPLICATIONS

This application claims priority to German Patent Application No. 10 2014 225 741.7, filed Dec. 12, 2014, the contents of which are hereby incorporated by reference in its entirety.

### TECHNICAL FIELD

The present invention relates to a gas exchange valve of an internal combustion engine having a valve plate and a valve stem. The invention further relates to a method and an apparatus for coating such a gas exchange valves.

### BACKGROUND

A species-related gas exchange valve of an internal combustion engine having a valve plate and a valve stem is known from DE 103 58 729 A1. In this case, a side of the valve plate facing away from a combustion chamber of the internal combustion engine has a catalytic coating, and a surface of the valve stem adjacent to the valve plate has an antiadhesive coating. This arrangement is intended in particular to prevent the gas exchange valve from becoming excessively coked during operation.

Gas exchange valves in internal combustion engines are generally exposed to high thermal and/or mechanical stresses. Besides the thermal stresses, chemical stresses, for example from oils, lubricants or other substances are also very significant, because they can often have a damaging effect on corrosion resistance, and therewith also wear resistance.

### SUMMARY

The present invention therefore addresses the problem of providing an improved, or at least an alternative embodiment of a gas exchange valve of the species-related kind, which is characterised in particular by greater resistance to wear and greater resistance to corrosion.

This problem is solved according to the invention by the object of the independent claim(s). Advantageous embodiments are the objects of the dependent claims.

The present invention is based on the general idea of providing a gas exchange valve of an internal combustion engine having a valve plate and a valve stem that is known per se with a nickel-phosphorus layer applied galvanically to at least areas of at least the valve stem, wherein such a layer has a phosphorus content greater than 10% by volume, particularly between 11 and 13% by volume. With such a very high phosphorus content of>10% by volume, it is possible to provide a hitherto unattainable level of corrosion protection. Surprisingly, a nickel-phosphorus layer created in this way also proved to be particularly resistant to intercrystalline corrosion, hot gas and condensate corrosion. In order to be able to obtain such a high phosphorus content, the galvanic fluid must first be mixed extremely well during galvanic coating, to ensure that phosphorus is present in sufficient quantity and that hydrogen generated during coating, which also collects on the valve profile, particularly in the region of the valve stem, does not interfere with the phosphorus deposition. Coating must also be carried out with a relatively low current density in the range from 3.5-4.5 A/dm². This is the current density range in which the maximum phosphorus content in the Ni-layer is achieved. However, this also necessitates longer coating times. In this context, an extremely homogeneous and even layer thickness distribution may be obtained by using a shaped anode for example.

The nickel-phosphorus layer expediently has a layer thickness of 8 μm≦d_{NP}≦15 μm. A layer thickness of this order not only guarantees high resistance to wear but also significantly greater corrosion protection for the gas exchange valve, which is exposed to high chemical stresses as well as high thermal and mechanical stresses, particularly when used as an inlet or outlet valve.

In an advantageous refinement of the solution according to the invention, a nickel strike layer is arranged as an adhesion layer between the gas exchange valve and the nickel-phosphorus layer, particularly in order to enable improved adhesion and thus improved bonding of the nickel-phosphorus layer on a high-alloyed valve steel. Such a nickel strike layer typically has a thickness of only 1 to 2 μm, yet still ensures an extremely strong bond between the nickel-phosphorus layer and the gas exchange valve.

In a further advantageous embodiment of the solution according to the invention, at least part of the nickel-phosphorus layer is covered with a layer of chromium. In this context, the provision of the chromium layer is entirely optional and it is applied in the form of a thin film, typically sealed impermeably and without cracks. This helps to increase the corrosion resistance further still. However, such an additional and purely optional chromium layer is only provided if there is a possibility that the improved resistance to wear already offered by the nickel-phosphorus layer will not be sufficient, particularly in conditions of extreme lubrication starvation. In such circumstances, particularly a valve guide region of the valve stem may be coated additionally with such a chromium layer, since the mechanic stresses arising there in addition to the thermal and chemical stresses are very high.

In an advantageous refinement of the solution according to the invention, the chromium layer and the nickel-phosphorus layer together have a thickness of<25 μm. In this way, a coating is created that represents the optimal solution in terms of function and cost.

The present invention is also based on the general idea of describing a method for coating a gas exchange valve in which a nickel strike layer is first applied to at least a valve guide region of the valve stem of the gas exchange valve that is to be coated. This nickel strike layer serves as a bonding agent for a nickel-phosphorus layer having a phosphorus content of>10% by volume, particularly having a phosphorus content between 11 and 13% by volume, that is to be applied to this region afterwards. In such case, the nickel strike layer has the form of a thin film and is typically only 1 to 2 μm thick. Even so, it provides the conditions for optimal bonding with the nickel-phosphorus layer that is intended to increase corrosion resistance and wear resistance. Particularly the high phosphorus content in the nickel-phosphorus layer is responsible for the good corrosion protection and is particularly effective in combating intercrystalline corrosion, hot gas and condensate corrosion.

In order to be able to further increase the resistance to wear as well as corrosion protection, at least part of the nickel-phosphorus layer may also be covered with a chromium layer. This chromium layer is typically crack-free and thus increases both corrosion resistance and wear resistance in conditions of lubricant starvation.

The present invention is based on the further general idea of describing an apparatus for coating a gas exchange valve that includes a galvanic bath with a galvanic fluid and an anode and a cathode disposed therein. In this context, the anode is equipped with a mounting in which the valve stem end of the gas exchange valve to be coated is fitted, and may particularly be centred, wherein the anode also has a negative contour of a throat of the gas exchange valve, and is thus able to retain the gas exchange valve to be coated in a fixed position in the anode. A cathode is also provided in the galvanic bath, which cathode may be placed flush against the base of the valve plate, so that electric current may be passed through said cathode into the gas exchange valve to perform the coating. Through the contact between the base of the valve plate and the cathode, the gas exchange valve thus serves as the actual cathode itself, and the retaining device that accommodates the gas exchange valve and surrounds the region of the gas exchange valve to be coated, particularly the valve stem, in the manner of a mesh, serves as the anode. Both are electrodes, and the anode is normally made from an insoluble mixed metal oxide (MMO anode), which has the advantage of not dissolving during the coating process, thereby guaranteeing a constant distance from the valve, and consequently even coating. In order to ensure that the galvanic bath is mixed well, of course a mixing device such a propeller or the like may also be provided to ensure that sufficient phosphorus is present and that that the hydrogen generated during coating that collects on the valve profile does not interfere with the deposition.

Further important features and advantages of the invention are described in the subordinate claims and the drawing, and will be deduced by reading the description of the drawing with reference to the associated figures.

Of course, the features described in the preceding text and those that will be explained in the following are usable not only in the respectively described combinations thereof, but also in other combinations or alone, without thereby departing from the scope of the present invention.

### BRIEF DESCRIPTION OF THE DRAWINGS

Preferred embodiments of the invention are represented in the drawings, and will be explained in greater detail in the following description, wherein identical or similar or functionally equivalent components are identified with the same reference signs.

In the drawings,

FIG. 1 is a schematic cross-sectional representation of a gas exchange valve according to the invention with an enlarged inset,

FIG. 2 is a schematic representation of an apparatus according to the invention for coating the gas exchange valve.

### DETAILED DESCRIPTION

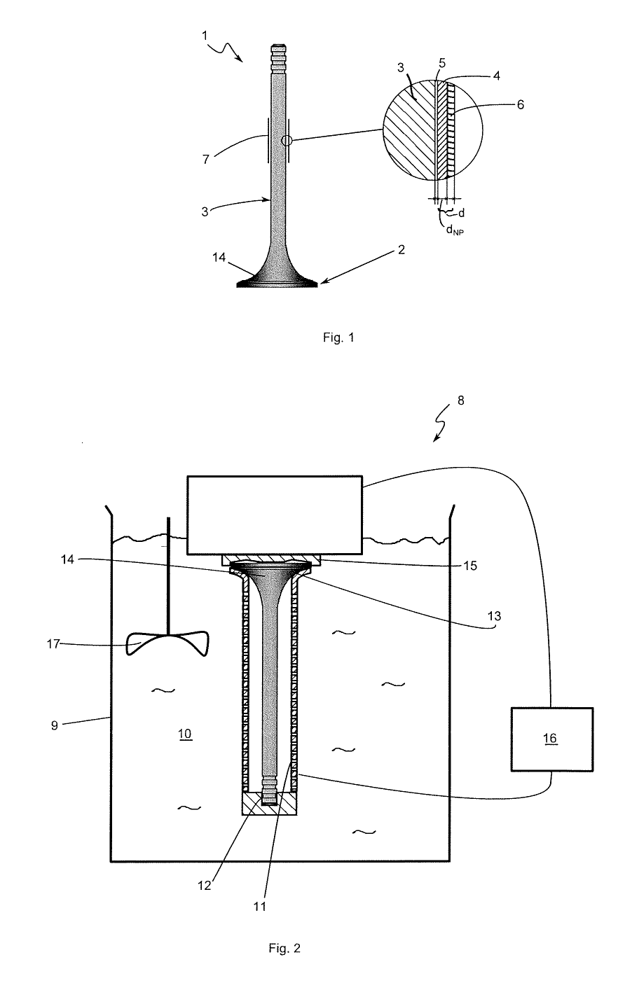

According to FIG. 1, a gas exchange valve 1 according to the invention in an internal combustion engine—not further shown—has a valve plate 2 and a valve stem 3. Gas exchange valve 1 usually has the form of an inlet valve or an outlet valve. In order to be able to provide increased corrosion and wear resistance when exposed to the high thermal, mechanical and chemical stresses that occur during operation of the internal combustion engine, at least a part of at least valve stem 3 of the gas exchange valve 1 according to the invention is coated with a galvanically applied nickel-phosphorus layer 4 (see also the enlarged inset in FIG. 1), wherein the coating has a phosphorus content>10% by volume. In fact, the phosphorus content of nickel-phosphorus layer 4 is ideally as high as between 11 and 13% by volume. This high phosphorus content is thus responsible for good corrosion protection, and nickel-phosphorus layer 4 is designed to provide protection particularly against intercrystalline corrosion, hot gas and condensate corrosion.

Nickel-phosphorus layer 4 typically has a layer thickness of 8 μm≦d_{NP}≦15 μm. In this context, in order to be able to create the best possible bond with the high-alloyed steel of valve stem 3, a nickel strike layer 5 may be provided between gas exchange valve 1 and nickel-phosphorus layer 4. Yet said nickel strike layer 5 is only 1 to 2 μm thick.

In order to be able to increase wear resistance and corrosion resistance still further, at least a part of nickel-phosphorus layer 4 may also be covered with chromium layer 6, which is applied in the form of a thin film, and is typically sealed impermeably and without cracks. However, such a chromium layer 6 is may be provided purely optionally, should the improved resistance to wear and corrosion already offered by nickel-phosphorus layer 4 prove insufficient. In total, chromium layer 6 together with nickel-phosphorus layer 4 should have a thickness d<25 μm. Since elevated mechanical stress occurs particularly in region 7 of a valve guide, and also requires greater resistance to wear and corrosion, it is advisable to apply the nickel-phosphorus layer 4 according to the invention and also the optional chromium layer 6 to this region 7.

Gas exchange valve 1 itself is made from a known, high-alloyed steel, for example X50CrMnNiNbN21-9 (1.4882) steel, a NiCr20TiAl (Nimonic 80A 2.4952) steel or a Nireva 3015 Steel.

In FIG. 2, an apparatus 8 for coating gas exchange valves 1 is shown, wherein apparatus 8 includes a galvanic bath 9 containing a galvanic fluid 10 with an anode 11 disposed therein. Anode 11 has a mounting 12 in which is fitted the valve stem end of gas exchange valve 1 that is to be coated, and a negative contour 13 that is shaped to complement a valve throat 14 of gas exchange valve 1. A cathode 15 is also provided and lies flush against the base of valve plate 2, and electric current may be passed from a current source 16 into gas exchange valve 1 through said cathode. In this the, gas exchange valve 1 thus serves as the actual cathode itself, through which electrical current flows toward anode 11. A mixing device 17 may also be provided, by means of which the galvanic fluid 10 is mixed well during the galvanic coating process, thereby ensuring that the phosphorus content is always high enough to enable the nickel-phosphorus layer 4 to be produced on the surface of valve stem 3. This also prevents the undesirable accumulation of hydrogen, which would interfere with the deposition of the phosphorus. In this context, anode 11 is typically a mixed metal oxide (MMO) anode. Of course, it is also conceivable to cover not only valve stem 3 but also at least valve throat 14 with nickel-phosphorus layer 4 according to the invention and optionally also chromium layer 6 in order to provide improved resistance to wear and corrosion.

With the nickel-phosphorus layer 4 according to the invention and its relatively high phosphorus content of>10% by volume, together with optional chromium layer 6, it has proven possible to provide particularly effective resistance to wear and corrosion, hitherto unattainable with comparable coatings.

1. A gas exchange valve of an internal combustion engine, comprising:
a valve plate and a valve stem, and
a nickel-phosphorus layer disposed on at least the valve stem, wherein the nickel-phosphorus layer has a phosphorus content greater than 10% by volume.

2. The gas exchange valve according to claim 1, wherein the nickel-phosphorus layer has a layer thickness of 8 μm to 15 μm.

3. The gas exchange valve according to claim 1, further comprising a nickel strike layer arranged between the valve stem and the nickel-phosphorus layer.

4. The gas exchange valve according to claim 1, further comprising a chromium layer disposed on at least part of the nickel-phosphorus layer.

5. The gas exchange valve according to claim 4, wherein the chromium layer and the nickel-phosphorus layer together define a total thickness of 25 μm or less.

6. The gas exchange valve according to claim 1, wherein the nickel-phosphorus layer is disposed only in a region of a valve guide on the valve stem.

7. The gas exchange valve according to claim 1, wherein at least one of the valve plate and the valve stem is composed of at least one of a X50CrMnNiNbN21-9 (1.4882) steel, a NiCr20TiAl (Nimonic 80A 2.4952) steel and a Nireva 3015 steel.

8. A method for coating a gas exchange valve comprising:
providing a valve stem and a valve plate;
dispersing a nickel strike layer galvanically at least in a region of a valve guide of the valve stem, and
applying a nickel-phosphorus layer galvanically at least in the region of the valve guide, wherein the nickel-phosphorus layer has a phosphorus content greater than 10% by volume.

9. The method according to claim 8, further comprising covering the nickel-phosphorus layer at least partly with a chromium layer.

10. An apparatus for coating a gas exchange valve comprising:
a galvanic bath and an anode disposed in the galvanic bath, wherein the anode includes a mounting configured to receive a valve stem end of a valve stem, and wherein the anode has a negative contour of a valve throat, and
a cathode configured to be placed flush against a base of a valve plate, wherein the cathode is configured to communicate an electrical current to at least one of the valve stem and the valve plate.

11. The apparatus according to claim 10, further comprising a mixing device disposed in the galvanic bath for mixing a galvanic fluid.

12. The gas exchange valve according to claim 1, wherein the phosphorus content ranges from 11% by volume to 13% by volume.

13. The gas exchange valve according to claim 12, wherein the nickel-phosphorus layer has a layer thickness of 8 μm to 15 μm.

14. The gas exchange valve according to claim 12, further comprising a chromium layer disposed on at least part of the nickel-phosphorus layer.

15. The gas exchange valve according to claim 14, wherein the chromium layer and the nickel-phosphorus layer together define a total thickness of 25 μm or less.

16. The gas exchange valve according to claim 12, further comprising a nickel strike layer disposed between the valve stem and the nickel-phosphorus layer.

17. The gas exchange valve according to claim 3, wherein the nickel strike layer has a thickness of 2 μm or less.

18. The gas exchange valve according to claim 17, wherein the phosphorus content ranges from 11% by volume to 13% by volume.

19. The gas exchange valve according to claim 3, wherein at least the valve stem is composed of at least one of a X50CrMnNiNbN21-9 (1.4882) steel, a NiCr20TiAl (Nimonic 80A 2.4952) steel and a Nireva 3015 steel.

20. The gas exchange valve according to claim 3, further comprising a chromium layer disposed on at least part of the nickel-phosphorus layer.
